(19) United States
(12) Patent Application Publication
(10) Pub. No.: US 2005/0187749 A1
(43) Pub. Date: Aug. 25, 2005

(54) Method, system, and computer program for performing carbohydrate/insulin calculation based upon food weight

(76) Inventor: Judy Singley, Doylestown, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 10/973,788

(22) Filed: Oct. 25, 2004

Related U.S. Application Data
(60) Provisional application No. 60/514,090, filed on Oct. 24, 2003.

(51) Int. Cl. G06G 7/48

(52) U.S. Cl. 703/11

(57) ABSTRACT

A technique is disclosed by which a weight scale, having electronic output, is couplable to a processing device such as a computer, and preferably, a hand-held computer, PDA, cell phone or the like. The processing device is configured to receive weight inputs from the weight scale and identification information of the food or food ingredients being weighed, and then convert the gram weight of the food into grams of carbohydrate and protein for that food. For diabetes applications, the process also converts the carbohydrate and protein information into rapid-acting insulin dosages which can then be used to determine manually the amount of insulin to be dosed to the person with diabetes. In a preferred embodiment, the calculated insulin dosages information is automatically provided to a insulin pump or other automatic means of dosing insulin to a patient to thereby automatically dose the patient properly.

### CROSS-REFERENCE TO RELATED APPLICATIONS

This application is based on and claims priority to U.S. Provisional Application No. 60/514,090, filed Oct. 24, 2003, which contents are incorporated fully herein by reference.

### BACKGROUND OF THE INVENTION

1. Field of the Invention

This invention relates to the field of diabetes management and, more particularly, to the field of the calculation of the proper insulin dosage in view of dietary intake.

2. Description of the Related Art

The primary goal for people with diabetes is to learn to manage their blood glucose levels to near normal levels to avoid the complications from diabetes. In particular, people with insulin-dependent Diabetes Mellitus must be able to determine their carbohydrate and protein intake with a degree of precision to enable them to determine their individual rapid-acting insulin dosage.

Currently, the best that people can do is read labels, guess weights, and calculate the carbohydrate and protein amounts based upon this imprecise method. While it is better to use this method than no method at all, it is imprecise and can result in improper insulin dosages. While ingredient lists and food charts display nutrient information, typically the basic unit of food measure (e.g., “serving size”) is vague, subjective, and sometimes inaccurate. Aside from the inaccuracy of measurement, the process of trying to make precise calculations with such imprecise data is psychologically challenging and impedes the self-management of the disease.

In addition to persons with diabetes, there are numerous diet programs currently being utilized that focus on carbohydrate and protein intake. As with the diabetes situation discussed above, calculation of these values is currently based primarily on guesswork.

The process of determining protein and carbohydrate intake is made even more difficult when the person wishing to have this information is dining in a restaurant or other location where labeling is not available and thus protein and carbohydrate information and weight information for the food that they are eating is likewise not available.

Accordingly, there is a need to have a simple, portable, and relatively inexpensive manner for accurately calculating the consumption of carbohydrates and protein in foods.

### SUMMARY OF THE INVENTION

The present invention is a method, system, and computer program by which a weight scale, having electronic output, is couplable to a processing device such as a computer, and preferably, a hand-held computer, PDA, cell phone or the like. The processing device is configured to receive weight inputs from the weight scale and identification information of the food or food ingredients being weighed, and then convert the gram weight of the food into grams of carbohydrate and protein for that food. For diabetes applications, the process also converts the carbohydrate and protein information into rapid-acting insulin dosages which can then be used to determine manually the amount of insulin to be dosed to the person with diabetes. In a preferred embodiment, the calculated insulin dosages information is automatically provided to an insulin pump or other automatic means of dosing insulin to a patient.

Other applications for the present invention include those on the Atkins diet (or similar low-carb diets), pulmonary patients, patients with hypoglycemia, cardiovascular device, and the like.

### BRIEF DESCRIPTION OF THE DRAWINGS

FIG. 1 illustrates a basic environment in which the present invention may operate;

FIG. 2 illustrates basic steps in accordance with the present invention utilized to gather information pertaining to food to be ingested and to calculate an appropriate insulin dose for a particular user of the system; and

FIG. 3 illustrates the basic steps performed in determining the adjustment to the meal bolus insulin dose due to HBG or LBG calculations.

### DETAILED DESCRIPTION OF THE PREFERRED EMBODIMENTS

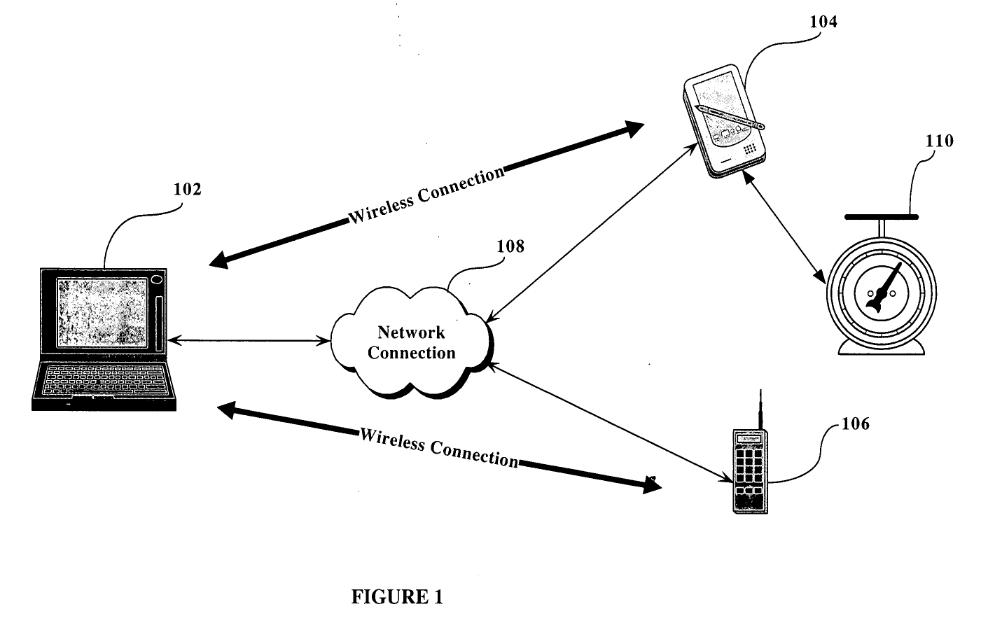

FIG. 1 illustrates a basic environment in which the present invention may operate. Referring to FIG. 1, a processing device 102, typically a laptop computer, desktop computer, or other similar device, is couplable to hand-held processing devices, e.g., PDA 104 and/or cellular telephone 106 via a network connection 108. It is understood that the network connection 108 can be an Internet connection, an internal local area network (LAN) connection, a direct connection between the processing device 102 and the hand-held processing device via a “sync cradle” as is well known, or the like. Optionally, the hand-held devices may also be linkable to the processor 102 via wireless connections (e.g., infrared, BlueTooth, WiFi).

A scale 110, preferably a portable scale that is easy to transport, is couplable to any of the processing devices, e.g., PC 102, PDA 104, or cellular telephone 106. In a typical use, the scale 110 would be connectable to, for example, PDA 104 via a serial cable (RS-232 or universal serial bus (USB)) or via infrared (IrDA), BlueTooth, or WiFi.

A functional embodiment of the present invention comprises an IBM ThinkPad, an Ohaus Scout Pro scale with Ohaus-specific serial cables; a Compaq IPAQ 3835 PDA; a null modem adaptor; a serial cable gender changer; and an RS232 to PDA cable. This information is provided only to describe a working embodiment and the present invention is not limited to these elements.

The PDA or other processing device which receives the weight information from the scale is programmed using known programming techniques to take the weight information and information identifying the type of foods being weighed and use one or more algorithms to calculate the grams of carbohydrate and protein and the rapid-acting insulin dosages. The system will be displayed to the user using, for example, a GUI interface which provides user-friendly menus, selection screens, etc. so that the user may input data, view the processing results, and utilize the processing results in known manners.

While the above discussion contemplates as the preferred embodiment a portable system, the present invention is not so limited and can be used using any weight scale device couplable to a processing device which can perform the calculations required based upon the input from the weight scale device. Further, while the above functional embodiment describes connection of the scale with the processing device via cables, the present invention also includes transmission of the data from the scale to the processor via other known means, for example, radio frequency transmission, infrared transmission, or other wireless connection techniques. Further, while the above description describes separate components, it is also understood that the scale and processor (e.g., PDA) can be combined into a single device.

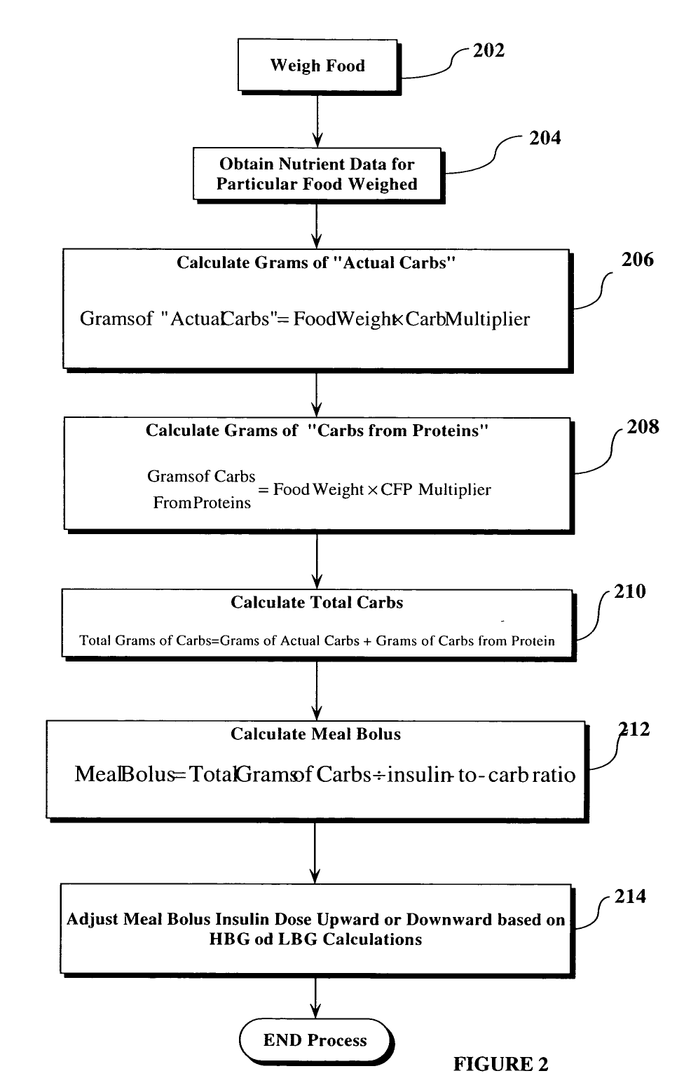

FIG. 2 illustrates basic steps in accordance with the present invention utilized to gather information pertaining to food to be ingested and to calculate an appropriate insulin dose for a particular user of the system. As described in more detail below, prior to utilizing the present invention to weigh food to be consumed, the processing device(s) being used by the user is populated with data relating to specific food items and ingredients as well as personal physical and medical information regarding the user.

Referring to FIG. 2, a user of the system couples the scale to the processing device being utilized, e.g., the PDA, and weighs the particular food available for consumption. As part of the weighing process, the user will first input identification information pertaining to that food, e.g., “baked potato”, and then place the food on the scale and execute the weighing process.

Executing the weighing process can be performed numerous ways, including automatically, or by interaction by the user with an interface, e.g., a graphical user interface (GUI) displayed on the processing device, or by pressing a physical button on the processing device or on the scale.

Once the scale weighs the food, at step 204, nutrient data for the particular food weighed is obtained from the information previously loaded to the system.

At step 206, the total grams of “actual carbs” in the food being weighed is calculated, using a pre-stored algorithm in the processing device. For example, the total grams of actual carbs in the food being weighed can be calculated by multiplying the weight of the food by a “carb multiplier”, which is simply the number of grams of carbs per a weight unit of the food (e.g., for a particular food item “A”, having a carb multiplier of 10 grams of carbs per ounce, if we weigh 3 ounces of food item “A”, we can calculate that we have 30 grams of carbs in the food to be eaten). This results in what is referred to herein as the total grams of “actual carbs”.

In addition to the actual carbs in the food, foods containing protein convert proteins to glucose, which has a “carbohydrate-like” affect on the body. For the purpose of this invention, this glucose is referred to as “carbs from protein”, although it is understood that the protein is not actually a carbohydrate. Thus, at step 208, the total grams of carbs from proteins is calculated. As with the calculation of the grams of “actual carbs”, the information needed to perform this calculation is obtained from the nutrient information stored on the processing device (a “carbs from protein” (CFP) multiplier) and the food weight of the particular food on the scale. Thus, for example, the grams of carbs from proteins can be calculated by taking the food weight of the food being weighed by the scale and multiplying it by a multiplier appropriate for the weight units being used to weigh the food. For example, it is known that 1 ounce of a “protein food” (e.g., meat, poultry, etc) equals 4.2 grams of carbs from protein. Thus, if we have 3 ounces of chicken, we can calculate that we have 12.6 grams carbs form that protein.

With this information, at step 210, the total carbs (the combination of actual carbs and carbs from protein sources) in the food being served can be calculated by simply adding the grams of actual carbs to the grams of carbs from protein sources.

At step 212, the meal bolus is calculated. As is well known, the meal bolus is the amount of rapid-acting insulin a person with insulin-dependent diabetes needs to take to match the carbohydrate and protein content of a meal, adjusted by the amount of insulin they may need to take to lower a high blood glucose level. This calculation is performed using an algorithm stored in the processing device. For example, the meal bolus can be calculated by taking the total grams of carbs calculated in step 210 and dividing it by the insulin-to-carb ratio of the individual whose levels are being calculated. This information is part of the personal information that the user inputs along with other physical parameters. The result of step 212 is the meal bolus insulin dosage, prior to adjusting the dosage for high blood glucose (HBG) or low blood glucose (LBG) calculations.

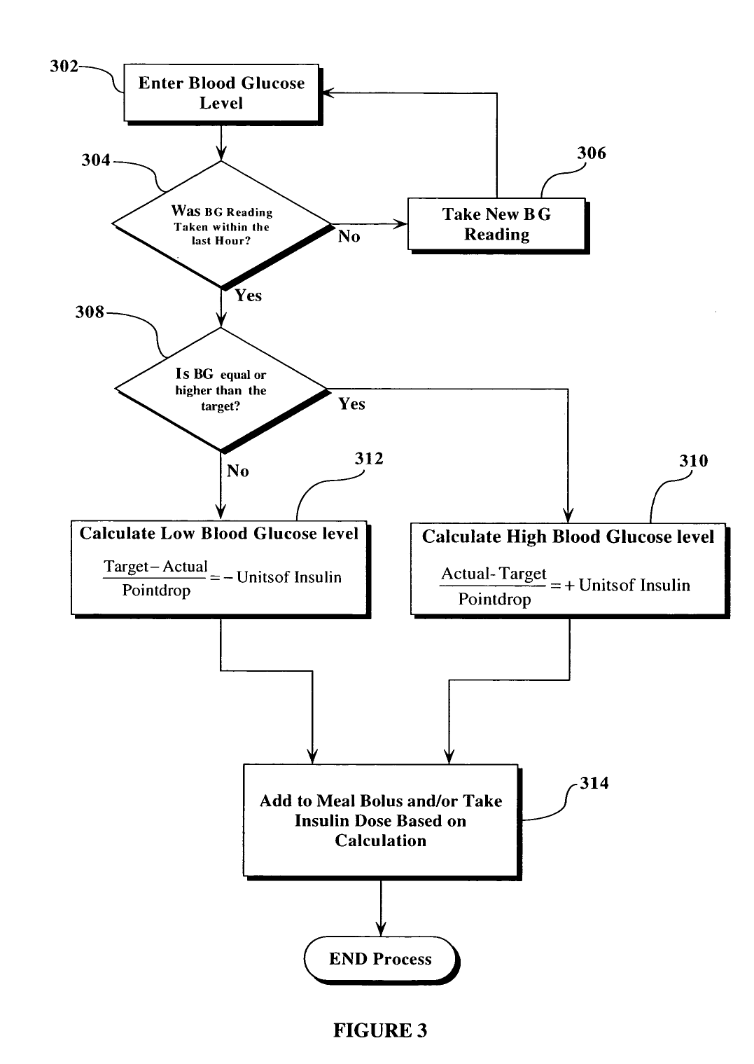

At step 214, an adjustment is made to the meal bolus insulin dose, either upward or downward, based upon the HBG or LBG calculations. These calculations are described with respect to FIG. 3.

FIG. 3 illustrates the basic steps performed in determining the adjustment to the meal bolus insulin dose due to HBG or LBG calculations. At step 302, the user's blood glucose level is entered into the processing device. This information may have been input earlier, or may be input on the fly, e.g., a current blood glucose entry.

At step 304, a determination is made as to whether or not the BG reading was taken within the last hour. This is done because it is important, particularly for precise dosing, to have as current a BG level reading as possible. If, at step 304, it is determined that the blood glucose reading was not taken within the last hour, the process proceeds to step 306, where a new blood glucose reading is taken (or, in the alternative, the user is warned of the importance of using a current blood glucose reading), and then the process proceeds back to step 302, where the new blood glucose level is entered.

If, at step 304, it is determined that the blood glucose reading has been taken within the last hour, then the process proceeds to step 308, where it is determined if the blood glucose level is above or equal to the target level of that particular user (which information is obtained from the user's personal information that has already been input into the system). If it is determined that the blood glucose level is less than the target value, then the process proceeds to step 312, where the low blood glucose level adjustment is calculated. This calculation can be performed by taking the target blood glucose level minus the actual level and then dividing that number by the point drop (a value that is particular to the user and is given to the user by his/her doctor, certified diabetes educator, or the like). The resulting number is the units of insulin that should be subtracted from the user's meal bolis dose.

If, however, at step 308, it is determined that the current BG level is equal to or higher than the target level, then the process proceeds to step 310, where the high blood glucose level adjustment is calculated. To perform this calculation, the processor takes the actual blood glucose level minus the the target value, and divides that by the point drop. The result of this calculation is the amount of insulin to be added to the meal bolis of the user and, at step 314, the user adds it to the meal bolis and/or takes the dose based upon this calculation.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation located in the PDA or other processing device. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The following scenarios will be considered:
a) User taking a meal—meal scenario
b) User taking a snack—snack scenario
c) User adding a BG reading—BG Reading scenario
d) User preparing to go to bed—Sleeping scenario

For each of these scenarios, it is recognized that the BG readings and insulin dosing can vary based on many factors, including stress levels, sickness, hormonal shifts, and medications being taken. How a users' body reacts to insulin dosing under these factors varies from individual to individual. It is envisioned that the user will be educated on watching his/her response to insulin in view of the above factors.

In a preferred embodiment, the tool and interface of the present invention will include a “main screen” that displays a collection of icons. Each icon can designate a particular scenario - for example, selecting the meal icon can initiate a Meal Scenario. A User Preferences icon may also be accessible to the user from a main screen. Following are examples of such scenarios. These examples are given for the purpose of explanation and it is not intended to limit the invention to these examples.

Meal Scenario

The following is the envisioned flow and interface of the user with the tool of the present invention:
1. The user initiates the Meal Scenario by clicking on the Meal icon on the Main Screen.
2. Tool displays a window that includes a Meal Plan prompt asking the user if (s)he wishes to weigh food with or without a plate. This option is provided because it is contemplated that situations will arise when the user may be weighing food with a plate in which case the plate's weight will need to be subtracted.
3. With plate—
   a. tool asks user to place plate on scale and its weight is determined
   b. tool asks user to place plate with food on the scale, so that the weight of the food can be determined by subtracting the weight of the plate
4. Without plate—tool asks user to place food on scale.
5. Next the tool asks the user to identify the food. The identification of the food can be made by reference to a menu of food items (e.g., baked potato, mashed potato, french fries, etc.). The menu of food items can be manually input by the user or provided to the user in the initial program utilized to obtain personal information regarding the user. Alternatively, external sources such as the FirstDataBank. Typically this information would reside on the main processor, e.g., PC 102 of FIG. 1, and would be transferred to the portable device by, for example, a syncing process.

Optional information about a particular food can be given to the user that might help in the process. For example, if a food has a tendency to be liquidy in nature, the user might be prompted to be sure to use a plate or bowl for making the measurement so that the liquidy food does not run off the scale.
6. Tool internally tracks the food and its weight and may do a partial meal bolus computation.
7. User is presented with a window where (s)he can:
   a. Select New Plate button to start a new plate or portion,
   b. Add more food without plate, or
   c. Finish
8. Tool computes the total carbohydrates, proteins and displays the computed meal bolus.
9. User is prompted to enter BG reading and time of reading, for HBG and LBG adjustments.
10. If the time of reading is older than an hour, user is prompted to take another reading.
11. HBG is computed ; LBG is computed if (and only if) BG is lower than target.
12. Tool displays a table with Bolus+HBG−LBG (if any).

The tool can record the event with the following pieces of information: Time of meal, Foods and weights, Meal Bolus computation, BG reading, time of BG reading (pre meal), meal type (Breakfast, lunch, dinner), HBG adjustment & LBG adjustment (if any).

Snack Scenario

The snack scenario is very similar to the Meal scenario, except the recording of BG readings, and computation of HBG and LBG adjustments are optional to the user. All of the information recorded as part of the Meal Scenario are also recorded here.

BG Reading Scenario

Following steps:
1. Tool prompts user to input BG reading and time and ensures that the time is within past hour, else prompts user to take another reading and re-enter
2. Computes HBG and if warranted LBG
3. Tool reports +units of insulin or add food
4. Tool recommends foods—15 grams of carbohydrates to raise the blood glucose level 50 points (can initially be a static list and later be customized to the user's preferences, needs or habits). This is for low blood glucose treatment if you are not going to subtract insulin from the dosage.

Sleeping Scenario

Ask user to take a BG reading and record it—so same as BG reading but time is that of bed-time.

It is understood that numerous other scenarios can and will be envisioned by those of ordinary skill in the art and such modifications and optional scenarios are considered included in the present application. For example, scenarios involving exercise and the effect of exercise on blood glucose levels may be included, to enable the user to input exercise data, track exercise regimens, and be given educational information regarding exercise programs.

Optional elements that can be added include the following:
1. Establish/require high and low watermarks or thresholds for readings—tool performs checks on high/low BG readings and indicates when readings are above or below thresholds, which might indicate faulty readings.
2. Tool computes premeal averages and before bed averages—and if readings available, post meal averages.
3. Tool displays averages in a graph.
4. If average is too low, a conclusion could be reached that there is too much insulin for activity level and food, and FAQ's or education modules can be provided, and/or a recommendation given for the user to call LMT or their doctor or CDE.
5. IF average is high, a conclusion could be reached that there is not enough insulin; could be stress- or medication-induced, for example. The tool could then suggest education modules, FAQ's, call LMT or their CDE or Doctor.

Look for patterns in insulin dosing and BG readings.

In summary, the present invention provides tools for people with diabetes to improve management of their blood glucose levels which will minimize th complications. This will change the currently known methods of diabetes management.

The process of weighing the food and the conversion to how much insulin to take, in accordance with the present invention, includes:
1. Input to a processing device (e.g., a PC) information about the following personal information: Name; Insulin to Carb ratio; Point drop per unit of insulin; Target range for bloodsugars; and Basal rates and time of day.
2. After input of the above information, downloading this information to a portable processing device, such as a PDA (can be done via syncing). Once on the portable processing device, the following steps can be performed via the portable processing device: receiving the weight of the food in grams from the scale; converting that gram weight into the amount of carbohydrates that is in that amount of food; input of the user's current blood sugar level; calculation of the increase or decrease of the needed insulin to stay in near-normal blood glucose range and then adding to the equation the number of carbs in the food and, resulting in the amount of insulin needed; and storage of the above information to the portable processing device so that it can be downloaded to (or synced with) the main processing device (e.g., the PC) for management purposes.

Once download back to the PC, there a management program of charts and graphs allows numerous tracking and other information: listing the time of day, carb intake, blood glucose and insulin recommended; averages of blood glucose levels and insulin recommended for certain periods of the day; and recommended changes to achieve improved blood glucose levels.

In the PC programming and in the PDA, there can be separate programs for Type 1 and Type 2 diabetes and for individuals that are counting carbs for dietary programs.

It is understood that numerous other embodiments of the present invention will be apparent and are considered as part of the present disclosure and fall within the claims appended below. For example, implantable insulin pumps exist which are implanted in the body and which contain an insulin supply that is releaseable based on the receipt of radio frequency signals directed to the pump from a transmitter outside the body. It is contemplated that the present invention can be utilized with such implantable pumps in a manner such that, for example, the results of the calculations based on the weight and nutrition information regarding the food-to-be-consumed, and the personal information pertaining to the physical characteristics of the pump user (as well as any other pertinent information input to the PDA or other processing device) can be transmitted wirelessly to the implanted pump to enable automatic dosing based on the calculations.

As another example, the present invention can be utilized to give a user educational information in addition to the dosing information that it calculates, and also deliver nutritional information unrelated to the insulin dosing, such as information on cardiac health (e.g., fat content such as saturated, polyunsaturated, and mono-unsaturated fats) and other such parameters, e.g., fiber content and the like. Similarly, educational information regarding adjustments to normal boluses and extended boluses can be presented to the user.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations.

1. A computer-based method for calculation of insulin levels based upon about-to-be-consumed food, comprising the steps of:
identifying the about-to-be-consumed food in a first processing device;
weighing said about-to-be-consumed food and inputting said weight into said first processing device;
obtaining nutritional information regarding said about-to-be-consumed food from said first processing device;
using said first processing device, calculating the total grams of carbohydrates in said about-to-be-consumed food;
obtaining personal information regarding a consumer of said about-to-be-consumed food from said first processing device;
calculating an insulin dose for said consumer based on said total grams of carbohydrates and said personal information; and
displaying said calculated insulin dose via said first processing device.

2. The method of claim 1, wherein said step of calculating the total grams of carbohydrates includes:
calculation of carbohydrates from non-protein sources.

3. The method of claim 2, wherein said step of calculating the total grams of carbohydrates further includes:
calculation of carbohydrates from protein sources.

4. The method of claim 3, further comprising a scale, coupleable to said first processing device, for weighing said about-to-be-consumed food and inputting the weight of said about-to-be-consumed food to said first processing device.

5. The method of claim 4, wherein said first processing device is a portable processing device, coupleable to a second processing device, wherein said nutritional information and personal information is stored on said second processing device and transferred to said first processing device by a synchronization process.

6. The method of claim 5, wherein said insulin dose calculation is performed using an algorithm stored on said first processing device.

7. The method of claim 6, wherein said algorithm is stored on said first processing device during said synchronization process.

8. The method of claim 1, wherein said first processing device is coupleable to an insulin pump, and wherein when said first processing device is coupled to said insulin pump, said calculated insulin dose is automatically input to said insulin pump to set said insulin pump to deliver said calculated insulin dose to a patient using said insulin pump.

9. A computer-based system for calculation of insulin levels based upon about-to-be-consumed food, comprising:
means for identifying the about-to-be-consumed food in a first processing device;
means for weighing said about-to-be-consumed food and inputting said weight into said first processing device;
means for obtaining nutritional information regarding said about-to-be-consumed food from said first processing device;
means for calculating, using said first processing device, the total grams of carbohydrates in said about-to-be-consumed food;
means for obtaining personal information regarding a consumer of said about-to-be-consumed food from said first processing device;
means for calculating an insulin dose for said consumer based on said total grams of carbohydrates and said personal information; and
means for displaying said calculated insulin dose via said first processing device.

10. The system of claim 9, wherein said means for calculating the total grams of carbohydrates includes:
means for calculating carbohydrates from non-protein sources.

11. The system of claim 10, wherein said means for calculating the total grams of carbohydrates further includes:
means for calculating carbohydrates from protein sources.

12. The system of claim 11, further comprising a scale, coupleable to said first processing device, for weighing said about-to-be-consumed food and inputting the weight of said about-to-be-consumed food to said first processing device.

13. The system of claim 12, wherein said first processing device is a portable processing device, coupleable to a second processing device, wherein said nutritional information and personal information is stored on said second processing device and transferred to said first processing device by a synchronization process.

14. The system of claim 13, wherein said insulin dose calculation is performed using an algorithm stored on said first processing device.

15. The system of claim 14, wherein said algorithm is stored on said first processing device during said synchronization process.

16. The system of claim 9, wherein said first processing device is coupleable to an insulin pump, and wherein when said first processing device is coupled to said insulin pump, said calculated insulin dose is automatically input to said insulin pump to set said insulin pump to deliver said calculated insulin dose to a patient using said insulin pump.

17. A computer-based computer program product for calculation of insulin levels based upon about-to-be-consumed food, the computer program product comprising a computer-readable storage medium having computer-readable program code embodied in the medium, the computer-readable program code comprising:
computer-readable program code that identifies the about-to-be-consumed food in a first processing device;
computer-readable program code that determines the weight of said about-to-be-consumed food and inputs said weight into said first processing device;
computer-readable program code that obtains nutritional information regarding said about-to-be-consumed food from said first processing device;
computer-readable program code that, using said first processing device, calculates the total grams of carbohydrates in said about-to-be-consumed food;
computer-readable program code that obtains personal information regarding a consumer of said about-to-be-consumed food from said first processing device;
computer-readable program code that calculates an insulin dose for said consumer based on said total grams of carbohydrates and said personal information; and
computer-readable program code that enables display of said calculated insulin dose via said first processing device.

18. The computer program product of claim 17, wherein said computer-readable program code that calculates the total grams of carbohydrates includes:
computer-readable program code that calculates carbohydrates from non-protein sources.

19. The computer program product of claim 18, wherein said computer-readable program code that calculates the total grams of carbohydrates further includes:
computer-readable program code that calculates carbohydrates from protein sources.

20. The computer program product of claim 19, further comprising a scale, coupleable to said first processing device for weighing said about-to-be-consumed food and inputting the weight of said about-to-be-consumed food to said first processing device.

21. The computer program product of claim 20, wherein said first processing device is a portable processing device, coupleable to a second processing device, wherein said nutritional information and personal information is stored on said second processing device and transferred to said first processing device by a synchronization process.

22. The computer program product of claim 21, wherein said insulin dose calculation is performed using an algorithm stored on said first processing device.

23. The computer program product of claim 22, wherein said algorithm is stored on said first processing device during said synchronization process.

24. The computer program product of claim 17, wherein said first processing device is coupleable to an insulin pump, and wherein when said first processing device is coupled to said insulin pump, said calculated insulin dose is automatically input to said insulin pump to set said insulin pump to deliver said calculated insulin dose to a patient using said insulin pump.
